(19) United States
(12) Patent Application Publication
(10) Pub. No.: US 2026/0110953 A1
(43) Pub. Date: Apr. 23, 2026

(54) CAMERA FRAME

(71) Applicant: TILTA INC., Burbank, CA (US)

(72) Inventors: Shujin FU, Shenzhen (CN); Wenping ZENG, Shenzhen (CN); Kefeng ZHOU, Shenzhen (CN)

(21) Appl. No.: 19/360,685

(22) Filed: Oct. 16, 2025

(30) Foreign Application Priority Data
Oct. 19, 2024 (CN) 202422543051.0

(51) Int. Cl. G03B 17/56

(52) U.S. Cl. CPC G03B 17/563; G03B 17/561; G03B 17/566

(57) ABSTRACT

A camera frame includes: a first frame assembly detachably arranged at the lower end of a camera, featuring a gripping position for convenient palm gripping; and a second frame assembly detachably arranged at the upper end of the camera, featuring a finger rest position for convenient finger placement. The first and the second frame assemblies are of a split-type design. During use, this split-type design allows for closer conformity with the shape of the camera, preventing interference with its normal operation. Additionally, the second frame assembly and/or the first frame assembly can be selectively installed as needed, providing greater flexibility in use.

### CROSS-REFERENCE TO RELATED APPLICATIONS

The present application for patent claims priority to and the benefit of pending Chinese Application No. 2024225430510, filed Oct. 19, 2024, and hereby expressly incorporated by reference herein as if fully set forth below in its entirety and for all applicable purposes.

### TECHNICAL FIELD

The present disclosure pertains to the field of camera accessories, more particularly to a camera frame.

### INTRODUCTION

Camera frames, as a type of camera accessory that fits around the exterior of a camera, have become increasingly popular among photography enthusiasts due to their ability to enhance ease of camera use. Current camera frames on the market typically include a base plate, a top plate, a left side plate, and a right side plate, which are sequentially connected to form an installation space for housing a camera. These camera frames are often equipped with expansion structures to mount the camera onto photographic accessories, such as a tripod, via the frame. However, when a user wishes to use the camera independently, the peripheral protrusion created by this type of camera frame around the camera body results in poor conformity, making it inconvenient for the user to handle the camera equipped with such a frame independently.

### BRIEF SUMMARY

Aspects of the present disclosure provide a camera frame that facilitates handheld use by the user when installed on a camera.

Some aspects of the present disclosure provide:

A camera frame including:
a first frame assembly detachably arranged at the lower end of an external camera, featuring a gripping position for convenient palm gripping;
a second frame assembly detachably arranged at the upper end of the external camera, featuring a finger rest position for convenient finger placement;
wherein the first and second frame assemblies are of a split-type design.

In this camera frame, during use, the second and first frame assemblies are installed on the camera respectively. The split-type design allows for closer conformity with the camera, avoiding excessive protrusion from the camera surface and preventing interference with its normal use. Furthermore, the second frame assembly and/or the first frame assembly can be selectively installed as needed, providing greater flexibility in use.

### BRIEF DESCRIPTION OF THE DRAWINGS

FIG. 1 is a diagram illustrating a camera frame in a first perspective according to some aspects of the disclosure.

FIG. 2 is a diagram illustrating the camera frame in a second perspective according to some aspects of the disclosure from a second perspective.

FIG. 3 is a diagram illustrating a first frame assembly, a second frame assembly, and a camera before assembly.

FIG. 4 is an exploded view of a quick release main body.

### REFERENCE NUMERALS

1. First frame assembly; 11. Base plate; 111. Battery avoidance port; 112. Heat dissipation avoidance port; 12. Grip handle; 121. Gripping position; 122. Second contact surface; 123. Finger placement groove; 13. Gasket; 131. First contact surface; 14. Handle protrusion; 141. Third contact surface; 142. Protrusion outer arc surface; 143. Arc-shaped avoidance port; 144. Protrusion fixing position; 145. First hanging hole; 15. Quick release assembly; 151. Quick release main body; 1511. Mounting slide groove; 1512. Quick release slide groove; 1513. Mounting cavity; 1514. Locking port; 152. Drive block; 1521. First drive inclined surface; 153. Locking block; 1531. Locking protrusion; 1532. Second drive inclined surface; 154. Drive shaft; 155. Eccentric lever; 1551. Eccentric part; 156. Return spring; 16. First fastening member; 17. Limiting part; 2. Second frame assembly; 21. Hot shoe handle; 211. Finger rest position; 212. Handle; 213. Hot shoe interface; 22. Top plate; 221. Fourth contact surface; 23. Second fastening member; 24. Upper side plate; 241. Fifth contact surface; 242. Upper side plate fixing position; 243. Second hanging hole; 3. Camera; 31. Camera bottom surface; 32. Camera side surface; 33. Camera operation member; 34. Camera hanging hole; 341. First camera hanging hole; 342. Second camera hanging hole; 35. Camera top surface.

### DETAILED DESCRIPTION

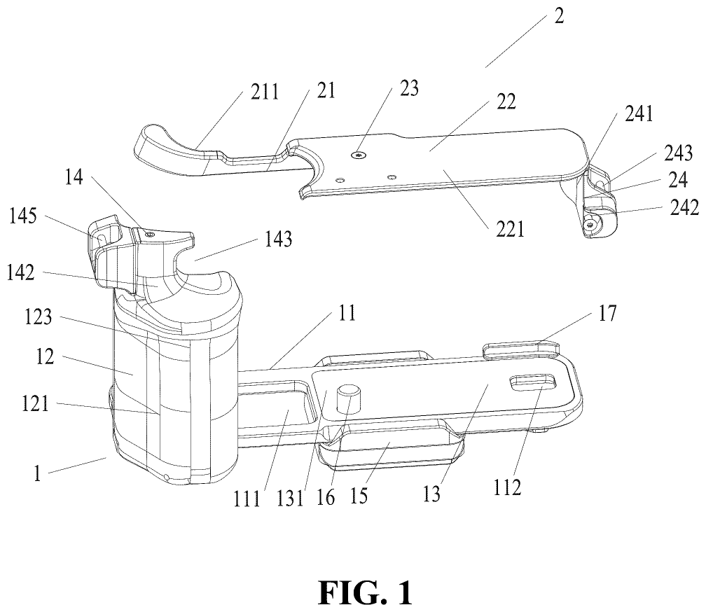

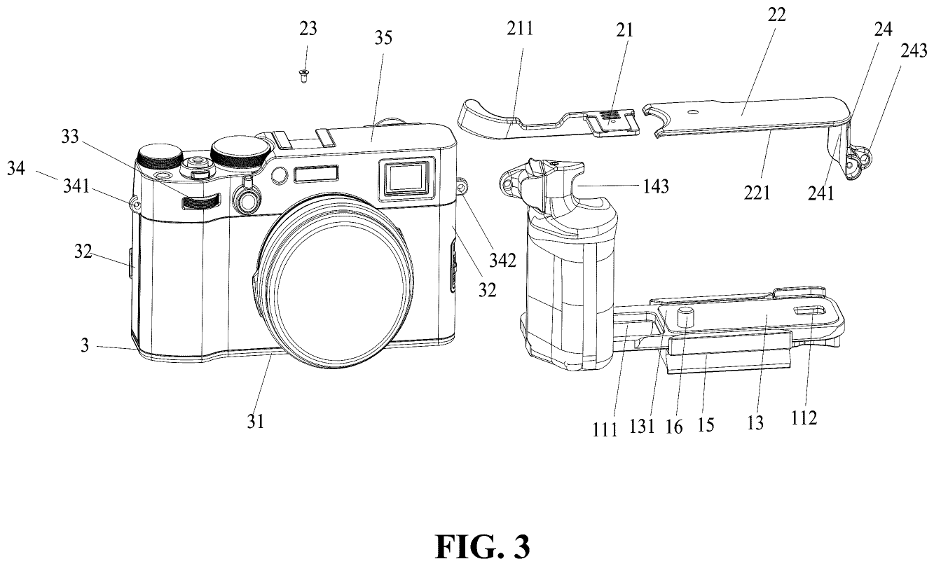

Referring to FIGS. 1-4, the present disclosure provides a camera frame including: a first frame assembly 1 detachably arranged at the lower end of a camera 3, featuring a gripping position 121 for convenient palm gripping; and a second frame assembly 2 detachably arranged at the upper end of the camera 3, featuring a finger rest position 211 for convenient finger placement. The first and second frame assemblies 1 and 2 are arranged in a split-type manner.

In some aspects, the term “split-type manner” indicates that the first frame assembly 1 and the second frame assembly 2 have no direct physical connection.

In this camera frame, during use, the first frame assembly 1 and the second frame assembly 2 are installed on the camera 3, respectively. The user can grip the camera with one hand via the gripping position 121 and rest fingers of the other hand on the finger rest position 211, making camera use less strenuous. The split-type design allows for closer conformity with the camera 3, avoiding excessive protrusion from its surface and preventing interference with its normal use. Furthermore, the first frame assembly 1 and/or the second frame assembly 2 can be selectively installed as needed, providing greater flexibility in use.

In some aspects, the first frame assembly 1 includes a base plate 11 and a grip handle 12. The grip handle 12 is fixed perpendicularly to the base plate 11. The base plate 11 features a first contact surface 131 for contacting the camera bottom surface 31, which matches the camera bottom surface 31. In some aspects, the base plate 11 can be provided with a gasket 13, whose side facing the camera forms the aforementioned first contact surface 131. The gasket 13 ensures a more stable connection between the base plate 11 and the camera 3. The grip handle 12 features a second contact surface 122 for contacting the camera side surface 32, and the side opposite the second contact surface 122 forms the gripping position 121. When the first frame assembly 1 is installed on the camera 3, the camera 3 can be gripped via the gripping position 121 on the grip handle 12, while the base plate 11 provides support. Specifically, the camera side surface 32 refers to the peripheral surface of the camera 3, e.g., the front, rear, left, and right surfaces.

In some aspects, the first frame assembly 1 further includes a limiting part 17 fixed to the base plate 11. The limiting part 17 and the grip handle 12 are located at diagonal corners of the base plate 11, respectively. When the first frame assembly 1 is installed at the lower end of the camera 3, the grip handle 12 and the limiting part 17 contact two opposite corners of the camera 3, respectively. When the user grips the camera 3 via the gripping position 121 on the grip handle 12, the limiting part 17 restricts the movement of the camera 3, preventing it from deflection.

In some aspects, the gripping position 121 is provided with a finger placement groove 123 for convenient finger placement. This finger placement groove 123 can be formed by an arcuate indentation at the top portion of the gripping position 121 of the grip handle 12. The second contact surface 122 is an arc-shaped surface conforming to the original grip area of the camera 3. The finger placement groove 123 makes it more convenient for the user to grip. The arc-shaped design of the second contact surface 122 allows the grip handle 12 to conform more closely to the original grip area of the camera 3.

In some aspects, a handle protrusion 14 is fixedly provided at the end of the grip handle 12 away from the base plate 11. The handle protrusion 14 features a third contact surface 141 for contacting the camera 3, and the side opposite the third contact surface 141 forms a protrusion outer arc surface 142 for easy gripping. In some aspects, the handle protrusion 14 is also provided with an arc-shaped avoidance port 143 to avoid interference with a camera operation member 33 (e.g., dial, switch, knob, etc.).

In some aspects, the handle protrusion 14 is provided with a protrusion fixing position 144 for securing to a camera hanging hole 34. Furthermore, the handle protrusion 14 cab also be provided with an attachment tie position (e.g., a first hanging hole 145). In some aspects, the protrusion fixing position 144 can be a screw hole. When the frame assembly is installed on the camera 3, this protrusion fixing position 144 aligns with a camera hanging hole 34. A screw can be installed through the camera hanging hole 34 and into the protrusion fixing position 144 to secure the grip handle 12 to the camera 3. The provision of the first hanging hole 145 provides an additional hanging hole or tie position for the camera 3.

In some aspects, the base plate 11 is provided with a first fastening member 16 for securing the base plate to the camera bottom surface 31. This first fastening member 16 can be a screw structure passing through the base plate 11 and into the camera 3 to fix the base plate 11 to the camera bottom surface 31. The connection between the base plate 11 and the camera bottom surface 31, combined with the connection between the handle protrusion 14 and the camera side surface 32, results in a more stable connection between the first frame assembly 1 and the camera 3, preventing deflection of the first frame assembly 1 after installation.

A quick release assembly 15 is detachably arranged on the base plate 11. In some aspects, the base plate 11 can be of a standardized quick-attach mounting rail design (e.g., NATO rail), and the quick release assembly 15 is a quick release mechanism compatible with the NATO rail, which can be installed on and removed from the base plate 11. Once installed on the base plate 11, it serves as a physical interface for expanding the accessories of the camera 3, such as for connecting the camera frame described herein to a gimbal, etc. In other aspects, it may be other specifications of rail designs, such as an Arca-Swiss rail, a Manfrotto rail, etc.

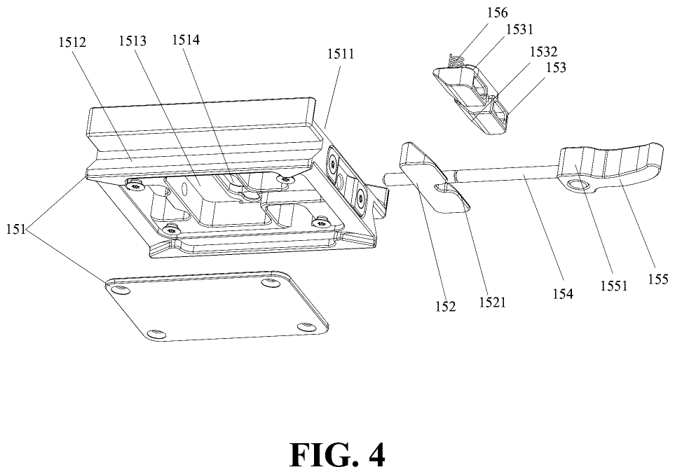

Referring to FIG. 4, in some aspects, the quick release assembly 15 includes a quick release main body 151, a drive block 152, a locking block 153, a drive shaft 154, an eccentric lever 155, and two sets of return springs 156. The side of the quick release main body 151 adjacent to the base plate 11 is equipped with a mounting slide groove 1511. On the opposite side of the quick release main body 151, away from the base plate 11, there is a quick release slide groove 1512. Inside the quick release main body 151, a mounting cavity 1513 is provided. The mounting slide groove 1511 features a locking port 1514 that penetrates through to the mounting cavity 1513. Both the drive block 152 and the locking block 153 are movably positioned within the mounting cavity 1513. A locking protrusion 1531 extends from the locking block 153 and is movably located at the locking port 1514. The drive block 152 has a first drive inclined surface 1521, while the locking block 153 has a second drive inclined surface 1532. The first drive inclined surface 1521 and the second drive inclined surface 1532 are in movable contact. The two sets of return springs 156 are positioned on opposite sides of the locking protrusion 1531, with each end of the return springs 156 connected to the side wall of the mounting cavity 1513 and the locking block 153, respectively. The drive shaft 154 is movably inserted into the mounting cavity 1513, passes through the locking block 153 in a movable manner, and is fixed to the drive block 152. The angle between the drive shaft 154 and the locking port 1514 is approximately perpendicular. The end of the drive shaft 154 away from the drive block 152 extends out of the quick release main body 151 and is hingedly connected to the eccentric part 1551 of the eccentric lever 155. Moreover, the eccentric part 1551 of the eccentric lever 155 is in movable contact with the quick release main body 151. The quick release assembly 15 is installed on the base plate 11 via the mounting slide groove 1511 and serves as a physical interface for attaching camera 3 accessories via the quick release slide groove 1512, for example, for connecting the camera frame described herein to a gimbal, etc.

In some aspects, when installing the quick release assembly 15 onto the base plate 11, the mounting slide groove 1511 is aligned with the base plate 11 and slid into place for installation. Then, by actuating the eccentric lever 155, the eccentric part 1551 moves on the quick release main body 151, causing the drive shaft 154 to pull the drive block 152 to move within the mounting cavity 1513. At this point, through the interaction of the first drive inclined surface 1521 and the second drive inclined surface 1532, the drive block 152 drives the locking block 153 to compress the return springs 156 and move closer to the base plate 11. The locking protrusion 1531 protrudes from the locking port 1514 to contact and lock onto the base plate 11. When it is necessary to remove the quick release assembly 15, the eccentric lever 155 is actuated in the reverse direction. The eccentric part moves on the quick release main body 151, causing the drive shaft 154 to push the drive block 152 to move within the mounting cavity 1513. A tendency for separation occurs between the first drive inclined surface 1521 and the second drive inclined surface 1532. At this time, under the restoring force of the return springs 156, the locking block 153 is driven away from the base plate 11, and the locking protrusion 1531 retracts from the locking port 1514 to disengage from the base plate 11. The quick release assembly 15 can then be slid out from the base plate 11.

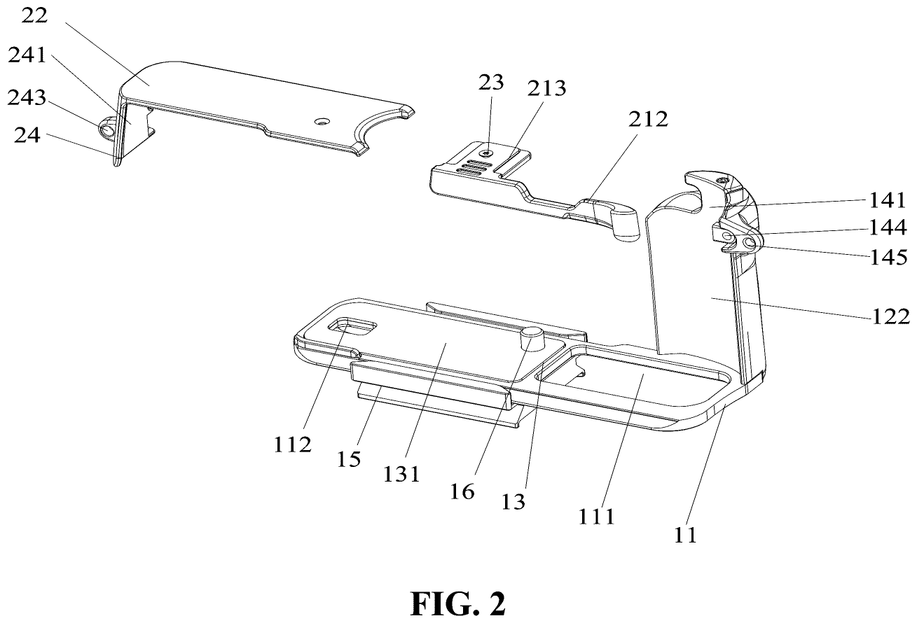

In some aspects, the base plate 11 is also equipped with a battery avoidance port 111 (see FIG. 2) to facilitate battery replacement for the camera 3 and a heat dissipation avoidance port 112 to facilitate heat dissipation for the camera 3.

In some aspects, the second frame assembly 2 includes a hot shoe handle 21. The hot shoe handle 21 includes a handle 212 and a hot shoe interface 213 for installation on the camera 3. The handle 212 is fixed to the hot shoe interface 213. A finger rest position 211 is formed on the handle 212. With the first frame assembly 1 and the second frame assembly 2 installed on the camera 3, the user can grip the grip handle 12 with one hand via the gripping position 121 and rest the other hand on the handle 212 via the finger rest position 211, making the use of the camera 3 less strenuous.

In some aspects, the second frame assembly 2 further includes a top plate 22 and a second fastening member 23 for securing the hot shoe handle 21 and the top plate 22 to the camera 3. The top plate 22 is provided with a fourth contact surface 221 for fitting installation against the camera top surface 35. The second fastening member 23 is connected sequentially to the top plate 22 and the hot shoe interface 213. In some aspects, the second fastening member 23 can be a screw structure. Corresponding screw holes are provided on both the hot shoe handle 21 and the top plate 22. Through the cooperation of the second fastening member 23 with the hot shoe handle 21 and the top plate 22, the hot shoe handle 21 and the top plate 22 can be installed on the camera top surface 35.

In some aspects, the second frame assembly 2 further includes an upper side plate 24. The upper side plate 24 is fixed to the top plate 22 and is provided with a fifth contact surface 241 for contacting the camera side surface 32. Specifically, the fifth contact surface 241 contacts the side of the camera side surface 32 opposite the side where the protrusion fixing position 144 is located.

In some aspects, the upper side plate 24 is equipped with an upper side plate fixing position 242 for securing to a camera hanging hole 34 (e.g., strap lug). Additionally, the upper side plate 24 is also provided with a second hanging hole 243 (e.g., strap lug). There can be two camera hanging holes 34, namely a first camera hanging hole 341 and a second camera hanging hole 342, located on the left and right sides of the camera, respectively. The protrusion fixing position 144 is connected to the first camera hanging hole 341, and the upper side plate fixing position 242 is connected to the second camera hanging hole 342. In some aspects, the structural configuration of the upper side plate fixing position 242 is substantially identical to that of the protrusion fixing position 144. The structural configuration of the second hanging hole 243 is substantially identical to that of the first hanging hole 145. The fixation via the upper side plate fixing position 242 and the second hanging hole 243, combined with the fixation of the top plate 22 to the camera top surface 35, results in a more stable connection between the second frame assembly 2 and the camera 3, preventing deflection of the second frame assembly 2 after installation. In some aspects, the thickness of the top plate 22 ranges from 1.2 mm to 2.0 mm, specifically it can be 1.8 mm or 2 mm. The thickness of the base plate 11 ranges from 1.5 mm to 4.5 mm, specifically it can be 4 mm. The thickness of the gasket 13 ranges from 0.5 mm to 1 mm, specifically it can be 1 mm. In some aspects, structures such as the top plate 22, base plate 11, grip handle 12, handle protrusion 14, hot shoe handle 21, and upper side plate 24 are all made of titanium alloy material. This allows the camera frame to be lighter and thinner while also effectively protecting the camera 3.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

Although specific embodiments of the invention have been described in detail, it should be understood that the invention is not limited to the exact configurations and components shown and described. Parts may be substituted, elements may be reversed, and certain features may be used independently of others, all without departing from the scope of the invention as defined by the claims. Various alternatives, modifications, and equivalents will be apparent to those skilled in the art. For example, the shape, dimensions, or materials of components may be varied, and mechanical linkages may be replaced with equivalent mechanisms that perform the same function. Such alternatives are considered to be within the scope of the invention as defined by the following claims.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. A camera frame, comprising:
a first frame assembly detachably provided at a lower end of a camera, wherein the first frame assembly is configured to provide a gripping position for facilitating palm gripping on the camera frame;
a second frame assembly detachably provided at an upper end of the camera, wherein the second frame assembly is configured to provide a finger rest position for facilitating finger resting on the camera frame; and
wherein the first frame assembly and the second frame assembly are provided separately.

2. The camera frame according to claim 1, wherein the first frame assembly comprises a base plate and a grip handle;
wherein the grip handle is fixedly provided on the base plate;
wherein the base plate is configured to provide a first contact surface for attaching to a camera bottom surface;
wherein the grip handle is configured to provide a second contact surface for attaching to a camera side surface; and
wherein the gripping position is on a side of the grip handle opposite to the second contact surface.

3. The camera frame according to claim 2, wherein the gripping position is configured to provide a finger placement groove for facilitating finger placement; and
wherein the second contact surface comprises an arc-shaped surface configured to attach to a grip portion of the camera.

4. The camera frame according to claim 2, wherein a handle protrusion is fixedly provided at an end of the grip handle away from the base plate;
wherein a third contact surface for attaching to the camera is provided on the handle protrusion; and
wherein a protrusion outer arc surface for facilitating gripping is on a side of the handle protrusion opposite to the third contact surface.

5. The camera frame according to claim 4, wherein one or more protrusion fixing positions for fixing to a camera hanging hole are provided on the handle protrusion; and
wherein a first hanging hole is further provided on the handle protrusion.

6. The camera frame according to claim 2, wherein the camera frame comprises a first fastening member, the first fastening member for fastening the base plate to the camera bottom surface is provided on the base plate; and
wherein a quick release assembly is detachably arranged on the base plate.

7. The camera frame according to claim 2, wherein the second frame assembly comprises a hot shoe handle ;
wherein the hot shoe handle comprises a handle and a hot shoe interface for mounting on the camera;
wherein the handle is fixed to the hot shoe interface; and
wherein the finger rest position is formed on the handle.

8. The camera frame according to claim 7, wherein the second frame assembly further comprises a top plate and a second fastening member;
wherein the top plate comprises a fourth contact surface for attaching to a camera top surface; and
wherein the second fastening member is connected to the top plate and the hot shoe interface.

9. The camera frame according to claim 8, wherein the second frame assembly further comprises an upper side plate;
wherein the upper side plate is fixed to the top plate; and
wherein the upper side plate comprises a fifth contact surface for attaching to the camera side surface.

10. The camera frame according to claim 9, wherein an upper side plate fixing position for fixing to a camera hanging hole is provided on the upper side plate; and
wherein one or more second hanging holes are further provided on the upper side plate.

11. The camera frame according to claim 8, the camera frame comprises a gasket that is provided on the base plate;
wherein the first contact surface is formed on the gasket;
wherein a thickness of the top plate is between 1.2 millimeters (mm) and 2.0 mm;
wherein a thickness of the base plate is between 1.5 mm and 4.5 mm; and
wherein a thickness of the gasket is between 0.5 mm and 1 mm.

12. The camera frame according to claim 11, wherein a thickness of the top plate is between 1.8 mm and 2 mm; or
the thickness of the base plate is 4.0 mm; or
the thickness of the gasket is 1 mm.
